(19) United States
(12) Patent Application Publication
(10) Pub. No.: US 2002/0026333 A1
(43) Pub. Date: Feb. 28, 2002

(54) System and process of health care, and storage medium where a health care program is stored

(76) Inventor: Makoto Endou, Tokyo (JP)

Correspondence Address: McGinn & Gibb, PLLC, 8321 Old Courthouse Road, Suite 200, Vienna, VA, 22182-3817, US

(21) Appl. No.: 09/929,144

(22) Filed: Aug. 15, 2001

(30) Foreign Application Priority Data
Aug. 23, 2000 (JP) 2000-251830

(51) Int. Cl. G06F 17/60

(52) U.S. Cl. 705/3

(57) ABSTRACT

A health care system is provided for analyzing a user's health on the basis of a large amount of health information and informing him or her of the danger of life style (related) disease. The system includes a health care center terminal connected via a network to a user terminal. The system also includes an analytic server connected to the health care center terminal. The health care center terminal has a diagnostic form display function for displaying on the user terminal a diagnostic form, in which the user can enter predetermined health information. The health care center terminal also has a health information reception function for receiving the information entered in the diagnostic form. The health care center terminal further has a health information transmission function for transmitting the received information to the analytic server. The analytic server has a health information database. The analytic server also has a health analysis function for receiving the transmitted information, and analyzing the user's health on the basis of the received information and the database. The analytic server further has an analyzed information transmission function for transmitting via the health care center terminal to the user terminal the information analyzed by the server.

### FIELD OF THE INVENTION

The present invention relates to a system and a process of health care. In particular, the invention relates to a system and a process of health care for analyzing the health of users and providing them with health guidance via a network. The invention also relates to a storage medium in which a program for health care is stored.

### BACKGROUND OF THE INVENTION

The living environment, such as the eating habits and the amount of physical exercise, of a human individual should be based on self-control. Suitable calorie intake, nutritional balance and so on are desired for each individual's body. Today, however, the development of the food service industry encourages opportunities to eat out, and many people skip breakfasts to sleep longer. This puts peoples' diet and nutrition out of balance. Furthermore, the lack of exercise due to desk work and the lack of sleep due to hard work tend to worsen human health increasingly. As a result, one may unconsciously contract a life style (related) disease or be a potential patient with it.

There are various health care instruments used conventionally to solve the foregoing problem. The health care instruments include thermometers, weight scales, body adipometers, sphygmomanometers, and so on. The use of these instruments enables self-control of health to some extent. In fact, however, the instruments cannot awake people to some diseases. For example, lifestyle (related) diseases are chronic diseases from which people of 40 or more years tend to suffer. These diseases are closely related to the items and quantity of a meal.

Japanese Patent Laid-Open Publication No. 10-74226 discloses a health care system for the prevention of life style (related) diseases. The health care system includes a computer equipped in a user's home and having a database in it. The user enters health data, such as his or her weight, into the computer. Based on the database, advice about meals, such as menus, is displayed on the computer. The computer is connected via a network to a medical institution. By transmitting the entered data to the medical institution, the user can obtain a doctor's professional advice.

However, in conventional health care system, a personal computer is used in home, so it is necessary to install in the computer in the user's home a database of health information and a program for outputting advice based on the database and the health data entered into the computer. In other words, the user has to buy such software, so that the health care system is time-consuming and costly.

It is also necessary to update the database of health information every day so that the computer can output up-to-date advice to provide the user with appropriate information. It is further necessary to upgrade the software, requiring time and cost.

The computation on the computer in the home limits the calculation speed and storage capacity, prohibiting computation based on a large number of parameters. This makes it difficult to compute meal and exercise menus based on a large quantity of entered data on food, drink, tobacco, physical exercise, etc. Consequently, the user can obtain no precise advice.

After the user transmits health data to the medical institution via the network, it is difficult for him or her to receive a doctor's professional advice in real time since the doctor is human. For example, even if the user wants to be advised about menus for the day when health data is transmitted, professional advice may be transmitted a few days later. Therefore, it may not be possible to obtain necessary advice when the advice is needed. This causes a time lag in the reception of advice.

SUMMARY OF THE INVENTION

An object of the present invention is to provide an improved health care system and an improved health care process for analyzing a user's health on the basis of a large amount of health information, informing him or her of the result of analysis and advice, and additionally informing him or her of the danger of life style (related) diseases to suppress the incidence of the diseases. Another object of the invention is to provide a storage medium in which a program for health care is stored.

In accordance with a first aspect of the present invention, a health care system is provided, which comprises a user terminal, a network, a health care center terminal and an analytic server. The user terminal is connected via the network to the health care center terminal, which can be accessed from the user terminal. The health care center terminal is connected to the analytic server, which analyzes health information supplied from the user terminal. The health care center terminal has a diagnostic form display function for displaying on the user terminal a diagnostic form, in which a user can enter predetermined health information, a health information reception function for receiving the health information entered in the diagnostic form, and a health information transmission function for transmitting the received health information to the analytic server. The analytic server has a health information database associated with the entered health information. The analytic server has a health analysis function for receiving the health information transmitted from the user terminal, and analyzing the user's health on the basis of the received health information and the health information database. The analytic server also has an analyzed information transmission function for transmitting via the health care center terminal to the user terminal the information analyzed by the health analysis function.

A browser or another application software that can display picture images or texts may be installed in the user terminal. The user terminal may be an apparatus that can be connected with Internet or another wide area network through a private line, a telephone line, a CATV cable or the like. The user terminal may be a personal computer or an apparatus built in a portable or home appliance. The network should preferably be Internet, but may be an intranet, which works only in a company or the like, or a network for communication with protocols other than TCP/IP. The health care center terminal maybe a server or another computer, which is connected via the network to the user terminal. The health care center terminal may constitute part of a site for the reception and transmission of information. It is preferable that the analytic server be a server computer, a work station or a super computer, which has a higher throughput than a personal computer.

The user can access the health care center terminal through the user terminal. This causes the diagnostic form to be displayed on the user terminal. The user can enter health information in the displayed diagnostic form. The health care center terminal receives the entered health information and transmits the received health information to the analytic server, which analyzes the user's health on the basis of the health information database. The analytic server transmits the analyzed information through the health care center terminal to the user terminal, so that the user can acquire the information about his or her health. If the analytic server is a computer of high throughput, it can process the analysis results on the basis of a large quantity of health information and databases, and consequently transmit precise analyzed information promptly to the user.

The analytic server may further have a user information accumulation function for registering and accumulating the received health information for each user in the analytic server. The analytic server may analyze the user's health with the health analysis function on the basis of the health information accumulated for each user in the analytic server and the health information database. This makes it possible to accumulate the health information for each user periodically (for example, every day) in the analytic server, and analyze the health information by additionally referring to the user's past health information. Therefore, more exact analysis results can be obtained, and the incidence of life style (related) illness can be suppressed more effectively.

The analytic server may further have a database update function for updating the health information database on the basis of the received health information. This keeps the health information database updated, making it possible to build a proper database for the period. On the basis of this, the user's health is analyzed. This makes it possible for the user to obtain more exact analysis results.

The analyzed information may be one or a combination of health judgment as to whether the health information entered by the user is a proper value or not, health guidance in response to the health information, and information about the danger of a life style (related) disease. The health judgment may be information that the user's weight is proper or, for example, 5 kilograms over the ideal weight. The health guidance may be a menu of a meal or physical exercise. The information about the disease danger may be predictive information as to how great the danger is. This enables the user to know if he or she is healthy. It is consequently easy for the user to try to improve his or her life style on the basis of the proposed menu. This also enables the user to try to improve the life style when the disease danger is small. It is consequently possible for the user to effectively suppress the incidence of the disease.

It is desirable that the health information entered by the user be one or a combination of diet information, exercise information, drinking information and smoking information on the user. On the basis of such information, the user's health is analyzed, and the health judgment, the health guidance, etc. are produced. This makes it possible for the user to know his or her health more exactly and improve his or her life style.

In accordance with a second aspect of the present invention, a health care process is provided, which comprises the steps of:

displaying on a user terminal connected via a network to a health care center terminal a diagnostic form, in which a user can enter health information;

receiving in the health care center terminal the health information entered in the diagnostic form;

transmitting the received health information to an analytic server connected to the health care center terminal, the analytic server having a health information database associated with the entered health information;

receiving the transmitted health information in the analytic server;

analyzing the user's health in the analytic server on the basis of the health information data base and the health information received in the analytic server; and

transmitting via the health care center terminal to the user terminal the information analyzed by the analytic server in the analyzing step.

In accordance with a third aspect of the present invention, a storage medium is provided, in which a health care program is stored as a command to operate the health care center terminal and the analysis server as mentioned above.

### BRIEF DESCRIPTION OF THE DRAWINGS

A preferred embodiment of the present invention will be described below with reference to the accompanying drawings, in which:

FIG. 1 is a block diagram of a health care system embodying the invention;

FIG. 2 is a flow chart of the operation of the health care system shown in FIG. 1;

FIG. 3 is a sequence chart of the operation of the health care system shown in FIG. 1;

FIG. 4 shows the diagnostic form displayed on each of the user terminals shown in FIG. 1.

### DETAILED DESCRIPTION OF A PREFERRED EMBODIMENT

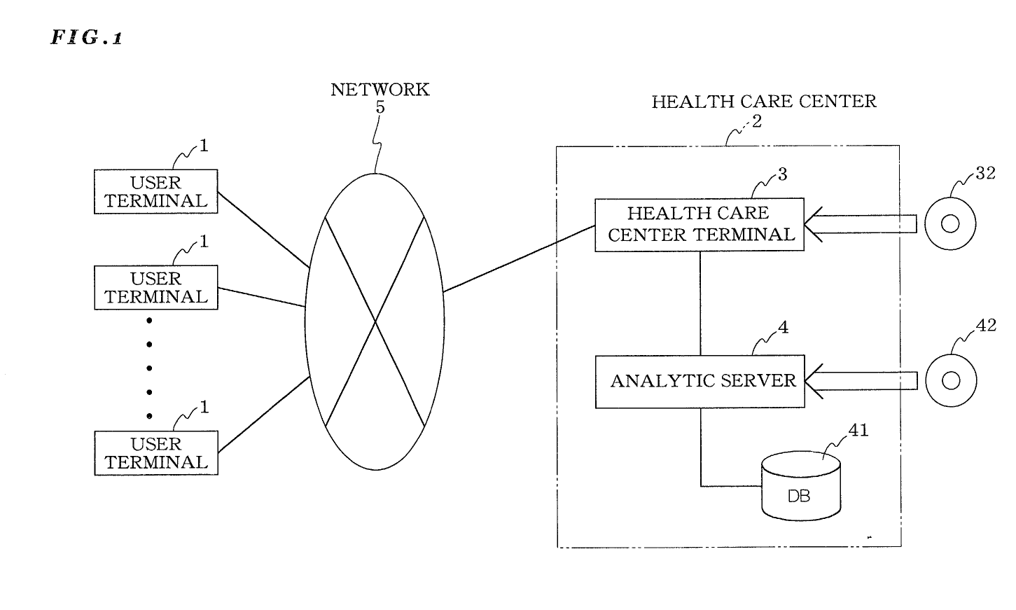

With reference to FIG. 1, a health care system embodying the present invention includes user terminals 1 and a health care center (site) 2, which is equipped with a health care center terminal 3. The user terminals 1 are connected to the health care center terminal 3 by Internet or another network 5. The health care center 2 is also equipped with an analytic server 4, which is connected to the health care center terminal 3 by a LAN and a WAN.

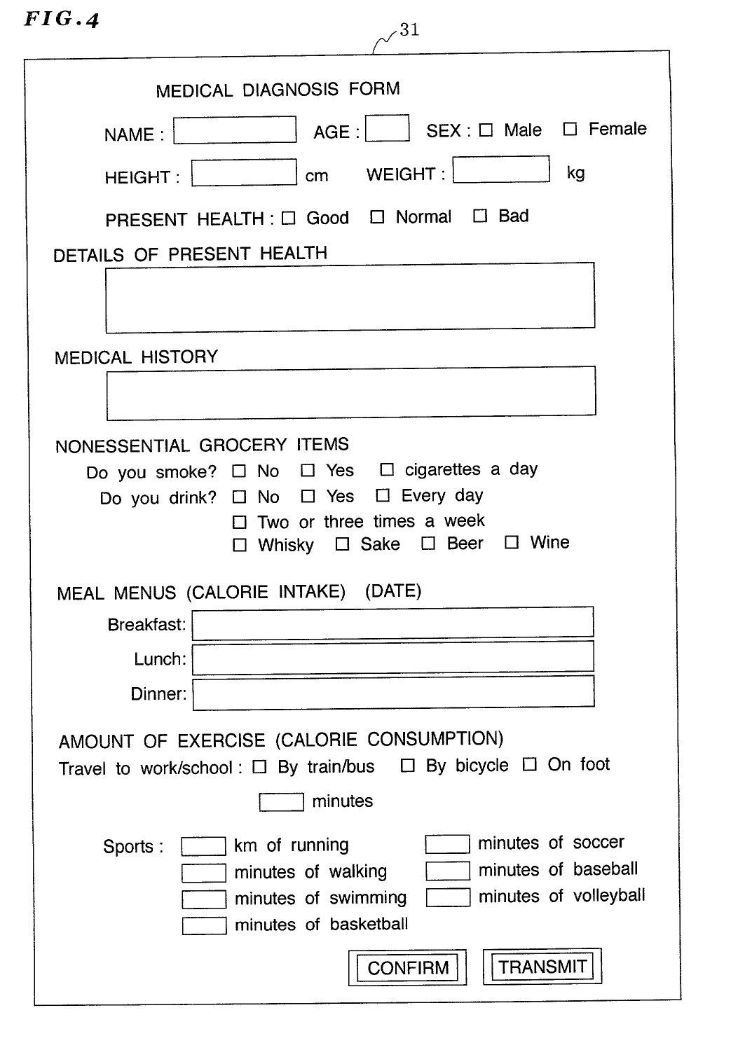

The user terminals 1 are personal computers or other information processors. The health care center terminal 3 provides a health care home page on the network 5. With reference to FIGS. 1 and 4, each user terminal 1 has a browsing function for displaying a diagnostic (health examination or physical checkup) form 31 on the screen of this terminal when this terminal accesses the home page. Each user of the health care system can enter health information about him/her in the diagnostic form 31. The diagnostic form 31 is provided by a function of the health care center terminal 3, which will be described later on.

The system users can enter personal information about them in the diagnostic forms 31 on their user terminals 1. The personal information may include the users' ages, heights, weights, health, clinical histories, chronic diseases, favorite foods, meals and exercises, and other information related to their physical conditions and health.

The establisher of the health care center 2 uses the health care center terminal 3, which may be a work station, a server or another information processor. The health care center terminal 3 has a diagnostic form display function for displaying the diagnostic form 31 on the user terminals 1, a health information reception function for receiving the health information entered in the diagnostic forms 31 by the users, and a health information transmission function for transmitting the received information to the analytic server 4. Thus, the users' health information entered at the user terminals 1 is transmitted via the health care center terminal 3 to the analytic server 4.

The analytic server 4 has a health information database 41, which is associated with the health information entered in the diagnostic forms 31. The database 41 may include the total number of daily calories that is ideal for a man of 40 years, for example. The database 41 may also include meal menus based on information about everyday meals. It is preferable that the analytic server 4 be a high-performance workstation, a high-performance server or a super computer.

The analytic server 4 receives the health information transmitted from the health care center terminal 3. The analytic server 4 has a health analysis function for analyzing the received health information on the basis of the database 41. The analytic server 4 analyzes the users' health by judging if the health information, which includes the users' ages, weights, etc., matches with the database 41.

The analytic server 4 transmits the analyzed information via the health care center terminal 3 and the network 5 to the user terminals 1 (analyzed information transmission function) Specifically, the users access the health care center 2 and transmit health information to it. While the health care center 2 is accessed, the analytic server 4 analyzes the transmitted information and transmits the analyzed information via the health care center terminal 3 and the network 5 to the users. Consequently, the users can obtain the analyzed information without waiting after entering the health information. This process, as stated earlier on, approaches real-time processing, during which the users do not need to wait, as the performance of the analytic server 4 becomes higher. In the meantime, the health care system can process a large amount of information at the same time. Consequently, it is possible to analyze the users' health by utilizing the large amount of information entered in the diagnostic forms 31. This makes it possible to analyze the health on the basis of more information, making the analysis accurate.

The analytic server 4 may have a user information accumulation function for registering and accumulating health information received for the respective users. The accumulation of health information for the respective users makes it possible to grasp the change with time of each user's health and analyze the health on the basis of this change.

The analytic server 4 may also have a data base update function for updating the database 41 every time this server receives health information. By making the data base 41 reflect many users' health, it is possible to keep the data base updated and gradually increase the amount of data accumulated in the data base. This makes the analysis more accurate.

It is preferable that the analyzed information transmitted from the analytic server 4 to the users include judgments as to whether the values of health information entered by the users are proper or not, health guidance in response to the health information, and information about the danger of life style (related) diseases. It is also preferable that the health information entered by the users include particulars (details) about what they ate and drank, what they do as exercises, whether and how much they drink, and whether and how much they smoke. This enables the analytic server 4 to manage the personal information about the users. This also enables the analytic server 4 to analyze the personal information, which includes the particulars about the meals, exercises, etc., and the diagnostic forms 31 on the basis of the data base 41, create health guidance, which may include meal menus and the quantity of exercise for the day, the next day or the week, and inform the users of the guidance. Moreover, the analytic server 4 can predict the danger of symptoms (seizure) of the users' life style (related) disease etc. on the basis of the causal relationship between the data on life style (related) diseases in the database and the information on the individual users' daily meals, exercises, etc. The analytic server 4 can inform the users of the prediction. Therefore, if the users can be informed of the prediction while the danger of the life style (related) diseases is comparatively slight, they can restrain the incidence of the diseases by improving their life styles subsequently.

The health care center terminal 3 and the analytic server 4, which are computers, run the programs for the foregoing process so that the foregoing functions can work and be realized. These programs for health care are stored in CD-ROMs 32 and 42, which are storage media, for use with the health care center terminal 3 and the analytic server 4, respectively. The storage media should not be limited to CD-ROMs, but might be FDs, MO (magneto-optical) disks or the like. The program might alternatively be downloaded from another server via the network 5.

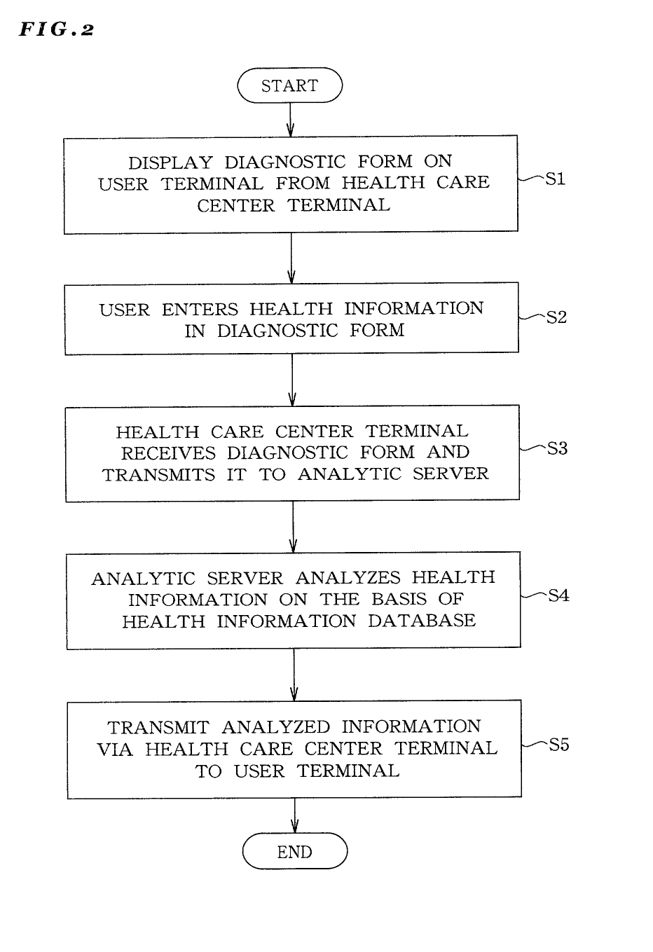

FIG. 2 is a flow chart showing the operation of this embodiment.

When each user terminal 1 accesses the health care center terminal 3 via the network 5, the diagnostic form 31 is displayed on the user terminal 1 (diagnostic form display step S1). The associated user enters health information on the displayed diagnostic form 31 (step S2).

The health care center terminal 3 receives the entered health information and transmits the received information to the analytic server 4 (health information reception and transmission step S3).

The analytic server 4 receives the transmitted health information and analyzes this received information on the basis of the database 41 in the server 4 (health information analysis step S4). The analytic server 4 transmits the analyzed health information via the health care center terminal 3 to the user terminal 1 accessing the health care center terminal 3 (analyzed information transmission step S5).

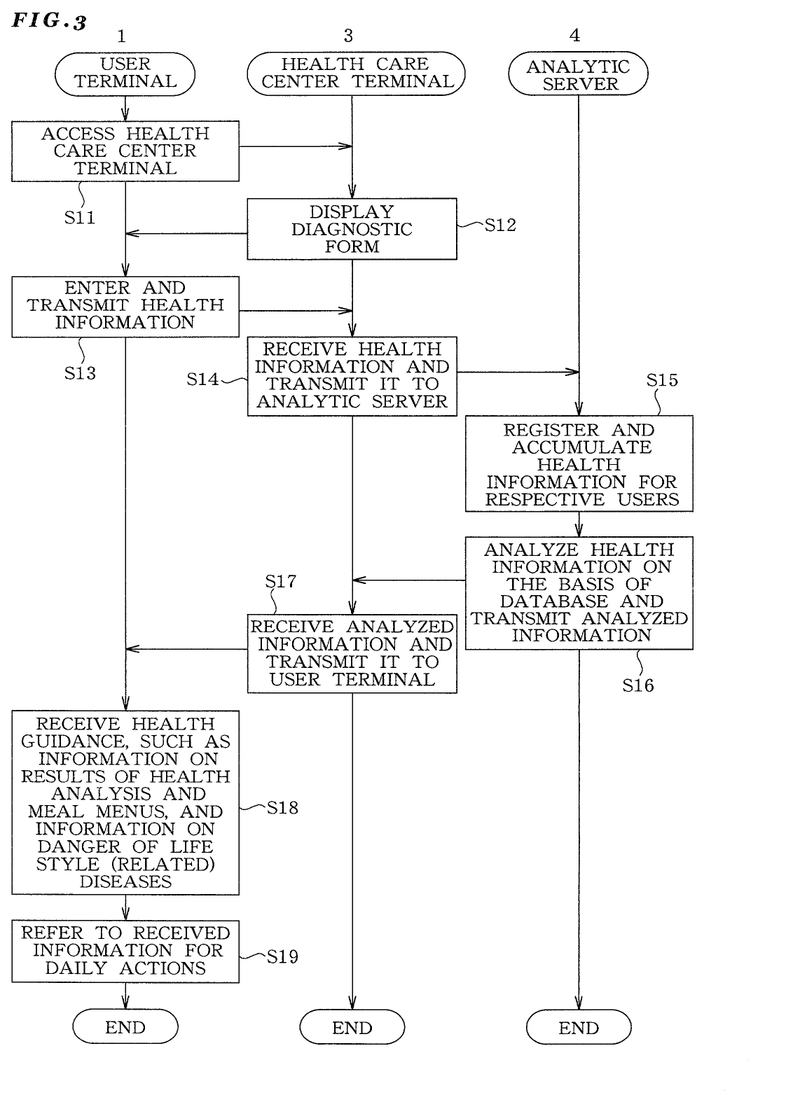

FIG. 3 is a sequence chart showing this operation in more detail.

Each user accesses through his or her user terminal 1 the life style (related) disease prevention home page established on Internet 5 by the health care center terminal 3 (step S11). In response to the access, the health care center terminal 3 transmits the information on the diagnostic form 31 to the user terminal 1, on which the diagnostic form is then displayed (step S12). Personal information as shown in FIG. 4 can be entered in the diagnostic form 31.

Seeing the diagnostic form 31 displayed on the user terminal 1, the user enters and registers personal information on his or her health etc. in the displayed form 31 (step S13). If the user clicks the box on the right of the item “NAME” on the diagnostic form 31, the cursor of the user terminal 1 moves into this box, where the user's name can be entered. If the user clicks the box on the right of the word “AGE” on the diagnostic form 31, the cursor moves into this box, where the user's age can be entered. If the user clicks the box on the right of the word “MALE” or “FEMALE” on the diagnostic form 31, the clicked box will be checked off. Likewise, the user fills in or checks off other boxes on the diagnostic form 31. The user also enters the details of the menus of the breakfast, lunch and dinner and the amount of the exercise for the day. The diagnostic form 31 with the personal information entered in it is stored temporarily in the user terminal 1.

Next, if the user clicks the “CONFIRM” button on the diagnostic form 31, it will be confirmed whether required (essential) items remain to be finished or not. If a required item is not finished, the cursor returns to the associated box and blinks, and the words “NOT FINISHED” will be displayed. If the user clicks the “CONFIRM” button after finishing all the required items, the word “OK” will be displayed. Subsequently, if the user clicks the “TRANSMIT” button on the diagnostic form 31, the health information entered in this form will be transmitted via Internet 5 to the health care center terminal 3 (step S13).

The health care center terminal 3 then receives the diagnostic form 31, which is the personal information about the user, and simultaneously transmits the received information, which is the health information, to the analytic server 4 (step S14). The analytic server 4 receives the transmitted health information, and registers, accumulates and manages it in the database 41 in this server (step S15).

On the basis of the received health information and the database 41 about data such as meal menus and the amount of exercise that are suitable for each physical condition, the analytic server 4 analyzes the user's health (step S16). The analytic server 4 then produces information on the results of the analysis of the user's present health, information on meal menus and the amount of exercise for the day or the next day, and other information (health guidance), and transmits the produced information via the health care center terminal 3 and Internet 5 to the user terminal 1 (steps S16 and S17).

The user terminal 1 receives the information (health guidance) transmitted from the health care center terminal 3 (step S18). The user can refer to the received information for his or her ingestion and actions or activities (step S19).

Every day, the user transmits information on the results of his or her ingestion and actions, such as the meal menus and the amount of exercise, for the day from the user terminal 1 via Internet 5 to the health care center terminal 3 (analytic server 4). Successively, the user receives reference information on meal menus, the amount of exercise, etc. from the health care center terminal 3 (analytic server 4) via Internet 5. In other words, the user repeats the steps S11-S19.

As stated above, the health care center terminal 3 receives information on the results of the user's everyday ingestion and actions, such as the menus and the amount of exercise, from the user terminal 1, and transmits it to the analytic server 4, which is connected to the health care center terminal 3 via a WAN or the like (steps S11-S14). The analytic server 4 receives the transmitted information, analyzes the user's health on the basis of the received information, and successively transmits reference information via the health care center terminal 3 and Internet 5 to the user terminal 1 (steps S15-S17). The user terminal 1 receives the reference information transmitted from the health care center terminal 3, so that the user can refer to the received information for his or her everyday actions (steps S18 and S19).

In the meantime, successively, the health information is managed and accumulated as personal information about the user in the analytic server 4, and the server 4 produces health guidance, such as information on meal menus and the amount of exercise, on the basis of the results of the analysis of the accumulated information and the basic data in the database 41.

The analytic server 4 predicts and analyzes life style (related) diseases on the basis of the results of the user's digestion and actions, such as the menus and the amount of exercise, accumulated as the diagnostic form and daily personal information, and the data on disease prevention, meal menus, the amount of exercise, etc. in the database 41. The analytic server 4 transmits the analysis results and prevention information periodically to the health care center terminal 3, from which the user terminal 1 receives them (step S18). The analytic server 4 may transmit the analysis results as information on the prevention of life style (related) diseases periodically to the user via the health care center terminal 3 and Internet 5.

This makes the user terminal 1 receive from the health care center terminal 3 the information on the prevention of life style (related) diseases as the results of the analysis based on the user's living environment (diet, exercise, etc.). On the basis of the disease prevention information about the user, he or she can improve or maintain the living environment, and live a comfortable life by taking care of himself or herself.

As described earlier on, the health care system embodying the present invention includes a health care center (site) established on a network. The health care center includes a health care center terminal connected via the network to user terminals, and can be accessed by users. The health care center also includes an analytic server connected to the health care center terminal. The analytic server has a database stored in it. Health information about the users can be transmitted from the user terminals via the health care center terminal to the analytic server. The analytic server has functions for analyzing the transmitted health information on the basis of the database and transmitting the analyzed information via the health care center terminal to the user terminals. If the analytic server is high in performance, it can analyze the users' health in real time on the basis of a large amount of data. This makes it possible to provide accurately analyzed information.

The analytic server may have a function for registering and accumulating health information for the respective users. In this case, the analytic server can analyze the users' health on the basis of the daily health information accumulated for the respective users. This makes it possible to provide each user with analyzed information proper for him or her, so that he or she can grasp his or her health more accurately.

The users may enter information on their daily meals, the amount of their daily exercise, etc. The analytic server may also have a function for informing the users of health guidance, such as menus of meals and exercise, in response to the entered information. In this case, the users can live healthy lives based on the guidance and be free from the trouble of planning menus of meals etc.

The analytic server may further have a function for informing the users of the danger of their life style (related) diseases in response to the entered health information. In this case, the users can keep grasping the danger of the life style (related) diseases, and accordingly be careful about their meals etc. when the danger is still slight. This makes it possible to effectively inhibit the users from developing the life style (related) diseases.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-251830 (Filed on Aug. 23, 2000) including specification, claims, drawings and summary are incorporated herein by reference in its entirety.

What is claimed is:

1. A health care system comprising:
a user terminal;
a network;
a health care center terminal connected via the network to the user terminal and able to be accessed from the user terminal; and
an analytic server for analyzing health information supplied from the user terminal, the analytic server being connected to the health care center terminal;
the health care center terminal having a diagnostic form display function for displaying on the user terminal a diagnostic form, in which a user can enter predetermined health information;
the health care center terminal also having a health information reception function for receiving the health information entered in the diagnostic form;
the health care center terminal further having a health information transmission function for transmitting the received health information to the analytic server;
the analytic server having a health information database associated with the entered health information;
the analytic server also having a health analysis function for receiving the health information transmitted from the user terminal, and analyzing the user's health on the basis of the received health information and the health information database;
the analytic server further having an analyzed information transmission function for transmitting via the health care center terminal to the user terminal the information analyzed by the health analysis function.

2. The health care system according to claim 1, wherein the analytic server further has a user information accumulation function for registering and accumulation the received health information for each user in the analytic server, the analytic server being adapted to analyze the user's health with the health analysis function on the basis of the health information accumulated for each user in the analytic server and the health information database.

3. The health care system according to claim 1, wherein the analytic server further has a database update function for updating the health information database for each users' on the basis of the received health information.

4. The health care system according to claim 1, wherein the analyzed information includes a health judgment as to whether the health information entered by the user is a proper value or not.

5. The health care system according to claim 1, wherein the analyzed information includes health guidance corresponding to the health information entered by the user.

6. The health care system according to claim 1, wherein the health information entered by the user includes diet information on the user.

7. The health care system according to claim 5, wherein the health information entered by the user includes diet information on the user, the health guidance including a diet menu based on the diet information.

8. The health care system according to claim 1, wherein the health information entered by the user includes exercise information on the user.

9. The health care system according to claim 5, wherein the health information entered by the user includes exercise information on the user, the health guidance including an exercise menu based on the exercise information.

10. The health care system according to claim 1, wherein the health information entered by the user includes smoking information on the user.

11. The health care system according to claim 1, wherein the health information entered by the user includes drinking information on the user.

12. The health care system according to claim 1, wherein the analyzed information includes information about the danger of a life style (related) disease of the user based on the health information entered by the user.

13. A health care process comprising the steps of:
displaying on a user terminal connected via a network to a health care center terminal a diagnostic form, in which a user can enter health information;
receiving in the health care center terminal the health information entered in the diagnostic form;
transmitting the received health information to an analytic server connected to the health care center terminal, the analytic server having a health information data base associated with the entered health information;
receiving the transmitted health information in the analytic server;
analyzing the user's health in the analytic server on the basis of the health information data base and the health information received in the analytic server; and
transmitting via the health care center terminal to the user terminal the information analyzed by the analytic server in the analyzing step.

14. A storage medium in which a health care program is stored for executing a process comprising the steps of:
displaying on a user terminal connected via a network to a health care center terminal a diagnostic form, in which a user can enter health information;
receiving in the health care center terminal the health information entered in the diagnostic form;
transmitting the received health information to an analytic server connected to the health care center terminal, the analytic server having a health information database associated with the entered health information;
receiving the transmitted health information in the analytic server;
analyzing the user's health in the analytic server on the basis of the health information data base and the health information received in the analytic server; and
transmitting via the health care center terminal to the user terminal the information analyzed by the analytic server in the analyzing step.
